(19) United States
(12) Patent Application Publication
(10) Pub. No.: US 2007/0059420 A1
(43) Pub. Date: Mar. 15, 2007

(54) Sweetener and aroma compositions

(76) Inventor: Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,629

(22) Filed: Sep. 13, 2005

(51) Int. Cl. A23L 1/236

(52) U.S. Cl. 426/548

(57) ABSTRACT

Compositions including a sweetener and an aroma component are provided. More particularly, compositions that sweeten and impart a scent to a foodstuff when added thereto are provided. Also provided are methods of making such compositions and methods of sweetening and imparting a scent to a foodstuff using such compositions.

### FIELD OF THE INVENTION

The present invention relates to compositions containing a sweetener and an aroma component. More particularly, the present invention relates to compositions that provide both sweetness and a scent to a foodstuff when added thereto. The present invention also relates to methods of making such compositions and methods of sweetening and imparting a scent to a foodstuff using such compositions.

### BACKGROUND OF THE INVENTION

People often customize the taste of food and beverages by adding sweeteners thereto. For example, sweeteners are added to beverages, such as, coffee and tea; on cereals; on fruit; as toppings on baked goods, and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from many sources e.g., sugar cane and sugar beet roots.

Sugar alcohols are another form of sweetener. Sugar alcohols are chemically alcohols, but are derived from sugar molecules. Sugar alcohols vary in sweetness from half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are therefore non-nutritive sweeteners.

Most foods engage more than one sense when consumed. Coffee, for example, has a both a taste and a distinct scent, which is essential to its sensory experience. Often, a coffee drinker's sensory experience begins well before the coffee is even poured. Likewise, meats and poultry, for example, have not only a taste and a scent, but also a texture, which is essential to their sensory experience. As proof of this, one need only look to the multitude of meatless food products on the market that attempt to achieve a meat-like texture.

Sucrose is the standard against which other sweeteners are measured. Sucrose is odorless, most often dissolved in a foodstuff and therefore has little effect on texture, and generally used in conjunction with other foods that impart other sensory attributes. Accordingly, work to improve sweeteners, both nutritive and non-nutritive, has been directed to mimicking sucrose and concerned with only one sense—taste.

Accordingly, it would be advantageous to provide a composition that delivers both sweetness and aroma to a food or beverage. In particular, it would be advantageous to provide a composition that provides low-calorie sweetness and an aroma component to food and beverages.

### SUMMARY OF THE INVENTION

One embodiment of the present invention is a composition comprising, consisting of and/or consisting essentially of a sweetener and an aroma component.

Another embodiment of the invention is a composition comprising, consisting of and/or consisting essentially of sucralose and an aroma component selected from the group consisting of essential oils (citrus oil), expressed oils (orange oil), distilled oils (rose oil), extracts (fruits), benzaldehyde, d-linonene, furfural, menthol, methyl butanoate, pentyl butanoate, and combinations thereof.

A further embodiment of the invention is a method of making a composition for sweetening and imparting a scent to a foodstuff. This method comprising, consisting of and/or consisting essentially of combining a sweetener and an aroma component.

Another embodiment of the invention is a method of making a composition for sweetening and imparting a scent to a foodstuff comprising, consisting of and/or consisting essentially of combining sucralose and an aroma component selected from the group consisting of essential oils (citrus oil), expressed oils (orange oil), distilled oils (rose oil), extracts (fruits), benzaldehyde, d-linonene, furfural, menthol, methyl butanoate, pentyl butanoate, and combinations thereof.

Another embodiment of the invention is a method of sweetening and imparting a scent to a foodstuff. This method comprising, consisting of and/or consisting essentially of mixing a foodstuff and a composition comprising, consisting of and/or consisting essentially of a sweetener and an aroma component.

Another embodiment of the invention is a method of sweetening and coloring a foodstuff comprising, consisting of and/or consisting essentially of mixing a foodstuff and a composition comprising, consisting of and/or consisting essentially of sucralose and an aroma component selected from the group consisting of essential oils (citrus oil), expressed oils (orange oil), distilled oils (rose oil), extracts (fruits), benzaldehyde, d-linonene, furfural, menthol, methyl butanoate, pentyl butanoate, and combinations thereof.

### DETAILED DESCRIPTION OF THE INVENTION

The present invention relates to subject disclosed in U.S. application Ser. No. ______, entitled “HIGH INTENSITY SWEETENERS AND COLORING AGENT COMPOSITIONS”, and U.S. application Ser. No. ______, entitled “A SELF-MIXING TABLETOP SWEETENER,” which were both filed on Sep. 13, 2005, and are hereby incorporated by reference as if recited in full herein.

One embodiment of the invention is a composition containing a sweetener and an aroma component.

As used herein, unless otherwise indicated, the term “sweetener” means any substance that produces a sweet taste when consumed and is deemed safe for human consumption. Sweeteners are generally grouped into two categories—nutritive and high intensity sweeteners.

As used herein, unless otherwise indicated, the term “nutritive sweetener” means a substance that provides sweetness and is also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from many sources e.g., sugar cane and sugar beet roots. Examples of nutritive sweeteners useful in the present invention include, e.g., corn syrup, glucose, fructose, tagatose, high fructose corn syrup, lactose, sucrose, trehalose, lactose, arabinose, trehalose, maltodextrin, soluble starch, inulin, and the like, alone or in combination.

As used herein, unless otherwise indicated, the term “high intensity sweetener” means a substance that provides a high sweetness per unit mass as compared to a nutritive sweetener and provides little or no nutritive value. Many high intensity sweeteners are known to those skilled in the art and any can be used in the present invention. Examples of high intensity sweeteners useful in the present invention include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof. A preferred high intensity sweetener according to the present invention is sucralose.

As used herein, unless otherwise indicated, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, unless otherwise indicated, the term “aroma component” means any food-grade volatile substance that may be employed to produce a desired scent, for example, when mixed with a foodstuff. Aroma components useful in the present invention include, hydrophilic aromas and hydrophobic aromas. Such aroma components include essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), ethyl butanoate (pineapple), d-limonene (orange), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone Ouniper, common sage, Nootka cypress, and wormwood), thymol (camphor-like), trimethylamine (fish), vanillin (vanilla), salts, derivatives, and combinations thereof. Preferred aroma components according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

The compositions of the present invention may be in any form commonly used to sweeten a foodstuff. Composition forms useful in the present invention include, for example, powders (e.g., loose powders), granules, tablets, cubes, slurries, and solutions. Preferably, the composition is in the form of granules.

The aroma component may be present in any amount in the composition. Preferably, the aroma component is present in an amount from about 2- to about 100-times the detectable amount. More preferably, the aroma component is present in an amount from about 2- to about 10-times the detectable amount. As used herein, unless otherwise indicated, the term “detectable amount” is the amount of the aroma component required to produce a scent detectable in the foodstuff, which usually ranges from a few parts per billion to about one hundred parts per million.

The detectable amount is different for each aroma component. For example, for aroma components from dried ground products, the detectable amount ranges from about 200 to about 2,000 ppm; for aroma components from essential oils, the detectable amount ranges from about 1 ppm to about 100 ppm in the finished product.

An aroma component produces a vapor pressure that indicates the strength of the scent it produces. This vapor pressure is dependent on the characteristics of the aroma component and the amount of the aroma component present. Preferably, the aroma component is present in the composition in an amount sufficient to produce an equilibrium vapor pressure of from about 0.00001 mm Hg to about 10 mm Hg in a foodstuff when the composition is added thereto. More preferably, the aroma component is present in the composition in an amount sufficient to produce a vapor pressure of from about 0.0001 mm Hg to about 1.0 mm Hg in a foodstuff when the composition is added thereto.

As used herein, all numerical ranges provided are intended to expressly include at least all numbers that fall between the endpoints of ranges.

In one embodiment, the composition additionally includes an additive. Additives useful in the present invention include, for example, flavors, texture enhancers, coloring agents, bulking agents, and combinations thereof.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “texture enhancer” means any food-grade material that may be added to the present compositions to provide a desired texture to a foodstuff. Texture enhancers useful in the present invention include, for example, guar gum, alginate, taro gum, gellan gum, xanthium gum, amalose, amalopectin, konjac, and combinations thereof.

As used herein, unless otherwise indicated, the term “coloring agent” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), Annatto Extract, Anthocyanis, Aronia/Redfruit, Beet Juice & Powder, Beta-Carotene, Beta-APO-8-Carotenal, Black Currant, Burnt Sugar, Canthaxanthin, Caramel, Carbo Medicinalis, Carmine, Carmine/Beta-Carotene, Carmine Blue, Carminic Acid, Carrot & Carrot Oils, Chlorophyll, Chlorophyllin, Cochineal Extract, Copper-Chlorophyll, Copper-Chlorophyllin, Curcumin, Curcumin/CU-Chlorophyllin, Elderberry, Grape & Grape Skin Extracts, Hibiscus, Lutein, Mixed Carotenoids, Paprika, Paprika Extract, Paprika Oleoresin, Riboflavin, Saffron, Spinach, Stinging Nettle, Titanium Dioxide, Turmeric, and combinations thereof.

As used herein, unless otherwise indicated, the term “bulking agent” means any food-grade material that may be added to the present compositions to increase the bulk of the composition without significantly increasing the calories contained in or the sweetness delivered by the composition. Bulking agents are useful in increasing the volume of a high intensity sweetener composition to increase the ease of use for the consumer, e.g., in accurately adding sweetness to a beverage. Bulking agents useful in the present invention include, for example, maltodextrin, fructo-oligosaccharides, polydextrose, inulin, fibersol, high amylase carbohydrates, resistant starches, derivatives, and combinations thereof.

The present invention may be delivered in any packaged form typically used for delivering a sweetener while providing a barrier to evaporation of the aroma component. Generally, the composition may be packaged for industrial or commercial use, such as, in the food services industry, or for use by consumers in the same manner as sugar. These packaged forms may include, for example, boxes, bags, envelopes, pouches, drums, tubs, and the like, and individual use (i.e., unit package) forms, such as packets. Examples of barriers to evaporation of the aroma component useful in the present invention include, for example, air tight seals, plastic or metal linings, metallized film, and others conventional barriers.

Another embodiment of the present invention is a composition containing sucralose and an aroma component selected from the group consisting of essential oils (citrus oil), expressed oils (orange oil), distilled oils (rose oil), extracts (fruits), benzaldehyde, d-limonene, furfural, menthol, methyl butanoate, pentyl butanoate, and combinations thereof.

A further embodiment of the present invention is a method of making a composition for sweetening and imparting a scent to a foodstuff. This method includes combining a sweetener and an aroma component. In a preferred embodiment, the sweetener is a high intensity sweetener. Preferably, the method includes combining sucralose and an aroma component selected from the group consisting of essential oils (citrus oil), expressed oils (orange oil), distilled oils (rose oil), extracts (fruits), benzaldehyde, d-limonene, furfural, menthol, methyl butanoate, pentyl butanoate, and combinations thereof.

The components of the composition may be combined by any means known in the art to combine dry components, dry and liquid components, or liquid components. Preferably, dry components are blended and liquid components or liquid and dry components are stirred if a solution or slurry is desired.

As used herein, unless otherwise indicated, the term “foodstuff” means any edible substance to which a sweetener may be added. Foodstuffs useful in the present invention include, for example, cereals, cakes, cookies, dairy products, beverages, e.g., coffee, tea, milk, and seltzer.

The compositions of the present invention may also include a food-grade additive as described above. These additives may be added in by any means known in the art to combine dry components or dry and liquid components, as described above. As used herein, unless otherwise indicated, the term “food-grade” material is one that conforms to the standards for foods deemed safe for human consumption set forth in the Codex Alimentarius produced by the World Health Organization (1999).

The amount and identity of the sweetener, aroma component, additives, amounts, composition forms, and packaging forms used in this method are as described above.

Another embodiment of the present invention is a method of sweetening and imparting a scent to a foodstuff. This method includes mixing a foodstuff and a composition containing a sweetener and an aroma component. A preferred embodiment of the present invention is a method of sweetening and imparting a scent to a foodstuff including mixing a food stuff and a composition comprising sucralose and an aroma component selected from the group consisting of essential oils (citrus oil), expressed oils (orange oil), distilled oils (rose oil), extracts (fruits), benzaldehyde, d-limonene, furfural, menthol, methyl butanoate, pentyl butanoate, and combinations thereof.

The foodstuff and composition containing a sweetener and an aroma component are mixed in any conventional manner known in the art. Methods of mixing the foodstuff and composition of the present invention include, for example, blending, hand-mixing, shaking, stirring, and sprinkling over the foodstuff.

The amount and identity of the sweetener, aroma component, additives, composition forms, and packaging forms used in this method are as described above.

The following examples are provided to further illustrate the compositions and methods of the present invention. These examples are illustrative only and are not intended to limit the scope of the invention in any way.

### EXAMPLES

### Example 1

Compositions of the present invention are made containing a sweetener and benzaldehyde, d-limonene, furfural, menthol, methyl butanoate, pentyl butanoate, and combinations thereof in the amounts shown in Table 1.

The components are blended in a dry blender until a homogeneous powder is formed. The resulting compositions are stored at a temperature below −10° C. in plastic bags from which the air has been evacuated.

TABLE 1
Sweetener and aroma component compositions.

| | | Aroma component(s) (g) | | | | | | Sweetener | |
|---|---|---|---|---|---|---|---|---|---|
| Comp. | | | D- | | | Methyl | Pentyl | | Amount |
| No. | Scent | Benzaldehyde | Limonene | Furfural | Menthol | Butanoate | Butanoate | Name | (g) |
| 1 | Caramel Almond | 0.05 | | 0.05 | | | | Sucralose | 0.15 |
| 2 | Orange Pineapple | | 0.05 | | | 0.05 | | Sucralose | 0.15 |
| 3 | Peppermint | | | | 0.10 | | | Sucralose | 0.15 |
| 4 | Apricot Orange | | 0.05 | | | | 0.05 | Sucralose | 0.15 |
| 5 | Caramel Apple | | | 0.05 | | 0.05 | | Sucralose | 0.15 |
| 6 | Caramel Almond | 0.05 | | 0.05 | | | | Sucrose | 99.0 |
| 7 | Orange Pineapple | | 0.05 | | | 0.05 | | Sucrose | 99.0 |
| 8 | Peppermint | | | | 0.10 | | | Sucrose | 99.0 |
| 9 | Apricot Orange | | 0.05 | | | | 0.05 | Sucrose | 99.0 |
| 10 | Caramel Apple | | | 0.05 | | 0.05 | | Sucrose | 99.0 |
| 11 | Caramel Almond | 0.05 | | 0.05 | | | | Saccharine | 0.33 |
| 12 | Orange Pineapple | | 0.05 | | | 0.05 | | Saccharine | 0.33 |
| 13 | Peppermint | | | | 0.10 | | | Saccharine | 0.33 |
| 14 | Apricot Orange | | 0.05 | | | | 0.05 | Saccharine | 0.33 |
| 15 | Caramel Apple | | | 0.05 | | 0.05 | | Saccharine | 0.33 |
| 16 | Caramel Almond | 0.05 | | 0.05 | | | | Aspartame | 0.50 |
| 17 | Orange Pineapple | | 0.05 | | | 0.05 | | Aspartame | 0.50 |
| 18 | Peppermint | | | | 0.10 | | | Aspartame | 0.50 |
| 19 | Apricot Orange | | 0.05 | | | | 0.05 | Aspartame | 0.50 |
| 20 | Caramel Apple | | | 0.05 | | 0.05 | | Aspartame | 0.50 |

To sweeten and impart a scent to a foodstuff, the compositions above are added to the foodstuff with mixing. About 0.01 gram of Composition Number 1, about 4 grams of Composition Number 6, about 0.02 gram of Composition Number 11, and about 0.025 gram of composition Number 16 are each added to an eight ounce cup of hot coffee. In each cup of coffee, approximately one teaspoon of sucrose equivalent sweetness is delivered and a caramel almond scent is imparted to the coffee. In a similar manner, the other compositions are added to foodstuffs to deliver sweetness and impart a scent to the foodstuffs.

The scope of the present invention is not limited by the description, examples and suggested uses herein and modifications can be made without departing from the spirit of the invention. Thus, it is intended that the present invention cover modifications and variations of this invention provided that they come within the scope of the appended claims and heir equivalents.

What is claimed is:

1. A composition comprising a sweetener and an aroma component.

2. A composition according to claim 1, wherein the sweetener is selected from the group consisting of a sugar alcohol, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof.

3. A composition according to claim 2, wherein the sweetener is sucralose.

4. A composition according to claim 1, wherein the aroma component is selected from the group consisting of essential oils, expressed oils, distilled oils, extracts, anethole, anisole, benzaldehyde, benzyl alcohol, camphor, cinnamaldehyde, citral, ethyl butanoate, d-limonene, eugenol, furaneol, furfural, linalool, menthol, methyl butanoate, methyl salicylate, neral, nerolin, pentyl butanoate, pentyl pentanoate, sotolon, strawberry ketone, 2-ethoxy-3-isopropylpyrazine, 2-methoxy-3-sec-butylpyrazine, 2-methoxy-3-methylpyrazine, thujone, thymol, trimethylamine, vanillin, salts, derivatives, and combinations thereof.

5. A composition according to claim 4, wherein the aroma component is selected from the group consisting of essential oils, expressed oils, distilled oils, extracts, benzaldehyde, d-linonene, furfural, menthol, methyl butanoate, pentyl butanoate, and combinations thereof.

6. A composition according to claim 1, wherein the composition is in a form selected from the group consisting of a powder, a granule, a tablet, a slurry, a cube, and a solution.

7. A method according to claim 1, wherein the aroma component is present in the composition in an amount from about 2- to about 100-times the detectable amount.

8. A method according to claim 7, wherein the aroma component is present in the composition in an amount from about 2- to about 10-times the detectable amount.

9. A composition according to claim 1, wherein the aroma component produces a vapor pressure from about 0.00001 mm Hg to about 10 mm Hg when the composition is mixed with a foodstuff.

10. A composition according to claim 9, wherein the vapor pressure is from about 0.0001 mm Hg to about 1.0 mm Hg.

11. A composition according to claim 1, contained within a packaged form comprising a barrier to evaporation of the aroma component.

12. A composition according to claim 11, wherein the packaged form is selected from the group consisting of boxes, bags, drums, tubs, individual use packets and combinations thereof.

13. A composition comprising sucralose and an aroma component, which is selected from the group consisting of essential oils, expressed oils, distilled oils, extracts, benzaldehyde, d-linonene, furfural, menthol, methyl butanoate, pentyl butanoate, and combinations thereof.

14. A method of making a composition for sweetening and imparting a scent to a foodstuff comprising combining a sweetener and an aroma component.

15. A method according to claim 14, wherein the sweetener is selected from the group consisting of a sugar alcohol, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neoliesperidin, saccharin, sucralose, stevia, thaumatin, salts, derivatives, and combinations thereof.

16. A method according to claim 15, wherein the sweetener is sucralose.

17. A method according to claim 14, wherein the aroma component is selected from the group consisting of essential oils, expressed oils, distilled oils, extracts, anethole, anisole, benzaldehyde, benzyl alcohol, camphor, cinnamaldehyde, citral, ethyl butanoate, d-limonene, eugenol, furaneol, furfural, linalool, menthol, methyl butanoate, methyl salicylate, neral, nerolin, pentyl butanoate, pentyl pentanoate, sotolon, strawberry ketone, 2-ethoxy-3-isopropylpyrazine, 2-methoxy-3-sec-butylpyrazine, 2-methoxy-3-methylpyrazine, thujone, thymol, trimethylamine, vanillin, salts, derivatives, and combinations thereof.

18. A method according to claim 17, wherein the aroma component is selected from the group consisting of essential oils, expressed oils, distilled oils, extracts, benzaldehyde, d-linonene, furfural, menthol, methyl butanoate, pentyl butanoate, and combinations thereof.

19. A method according to claim 14, wherein the composition is in a form selected from the group consisting of a powder, a granule, a tablet, a slurry, a cube, and a solution.

20. A method according to claim 14, wherein the aroma component is present in the composition in an amount from about 2- to about 100-times the detectable amount.

21. A method according to claim 20, wherein the aroma component is present in the composition in an amount from about 2- to about 10-times the detectable amount.

22. A method according to claim 14, wherein the aroma component produces a vapor pressure from about 0.00001 mm Hg to about 10 mm Hg when the composition is mixed with a foodstuff.

23. A method according to claim 22, wherein the vapor pressure is from about 0.0001 mm Hg to about 1.0 mm Hg.

24. A method of making a composition for sweetening and imparting a scent to a foodstuff comprising combining sucralose and an aroma component selected from the group consisting of essential oils, expressed oils, distilled oils, extracts, benzaldehyde, d-linonene, furfural, menthol, methyl butanoate, pentyl butanoate, and combinations thereof.

25. A method of sweetening and imparting a scent to a foodstuff comprising combining a foodstuff and a composition comprising a sweetener and an aroma component.

26. A method according to claim 25, wherein the sweetener is selected from the group consisting of a sugar alcohol, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof.

27. A method according to claim 26, wherein the sweetener is sucralose.

28. A method according to claim 25, wherein the aroma component is selected from the group consisting of essential oils, expressed oils, distilled oils, extracts, anethole, anisole, benzaldehyde, benzyl alcohol, camphor, cinnamaldehyde, citral, ethyl butanoate, d-limonene, eugenol, furaneol, furfural, linalool, menthol, methyl butanoate, methyl salicylate, neral, nerolin, pentyl butanoate, pentyl pentanoate, sotolon, strawberry ketone, 2-ethoxy-3-isopropylpyrazine, 2-methoxy-3-sec-butylpyrazine, 2-methoxy-3-methylpyrazine, thujone, thymol, trimethylamine, vanillin, salts, derivatives, and combinations thereof.

29. A method according to claim 28, wherein the aroma component is selected from the group consisting of essential oils, expressed oils, distilled oils, extracts, benzaldehyde, d-linonene, furfural, menthol, methyl butanoate, pentyl butanoate, and combinations thereof.

30. A method according to claim 29, wherein the composition is in a form selected from the group consisting of a powder, a granule, a tablet, a slurry, a cube, and a solution.

31. A method according to claim 25, wherein the aroma component produces a vapor pressure from about 0.00001 mm Hg to about 10 mm Hg when the composition is mixed with a foodstuff.

32. A method according to claim 31, wherein the vapor pressure is from about 0.0001 mm to about 1 mm Hg.

33. A method of making a composition for sweetening and imparting a scent to a foodstuff comprising combining a foodstuff with a composition comprising sucralose and an aroma component selected from the group consisting of essential oils, expressed oils, distilled oils, extracts, benzaldehyde, d-linonene, furfural, menthol, methyl butanoate, pentyl butanoate, and combinations thereof.
